(19) United States
(12) Patent Application Publication
(10) Pub. No.: US 2005/0276397 A1
(43) Pub. Date: Dec. 15, 2005

(54) System and method for providing availability information to a user

(76) Inventors: Cynthia Hiatt, San Jose, CA (US); Erik J. Johnson, Campbell, CA (US); Doree Duncan Seligmann, New York, NY (US); Ross Yakulis, Los Gatos, CA (US)

Correspondence Address: Ryan, Mason & Lewis, LLP, Suite 205, 1300 Post Road, Fairfield, CT, 06824, US

(21) Appl. No.: 10/868,627

(22) Filed: Jun. 15, 2004

(51) Int. Cl. H04M 11/00; H04M 1/56; H04M 15/06

(52) U.S. Cl. 379/90.01; 379/93.17

(57) ABSTRACT

A system and method are disclosed for managing incoming transmissions received from a sender. A recipient availability indication is generated as a function of recipient availability data and, optionally, a classification level for the transmission. The recipient availability indication is provided to the recipient. The recipient can optionally validate or modify the recipient availability data.

### FIELD OF THE INVENTION

The present invention relates generally to techniques for providing indication information to a user and, more particularly, to techniques for providing a message recipient with the indication of availability that has been provided to the sender.

### BACKGROUND OF THE INVENTION

Many telephone and Internet users often receive unwanted telephone calls and emails. A number of conventional techniques exist for filtering communications in a telephone network. For example, Caller ID features identify a caller and allow a called party to decide whether to answer a given incoming telephone call based on the identity of the caller. Some telephone service providers also offer services to screen incoming calls automatically based on do not disturb lists so a user is not disturbed by telephone calls from unwanted parties.

Also, a number of conventional techniques exist for filtering email. For example, one electronic document delivery system periodically ascertains whether the end user terminal is busy. If so, the transmission to the end user is terminated and the information is stored until such time as the “busy” indication is terminated. An indication for the recipient of incoming information is in the form of an icon generated on-screen, which the recipient can click to obtain the sought-after information.

Automated agents may be used by recipients to filter incoming telephone and email transmissions, and it would be an advancement in the state of the art to enable a recipient to provide availability information to a sender and for the recipient to receive feedback regarding the availability information that has been provided to the sender.

### SUMMARY OF THE INVENTION

Generally, a method and system are disclosed for managing incoming transmissions received from a sender. An availability indication is generated as a function of recipient availability data and, optionally, a classification level for the transmission. The availability indication is provided to the recipient. According to another aspect of the invention, a coarse, or global setting of availability can optionally be established for the recipient, and exceptions to the coarse setting can be made.

Thus, an incoming transmission is classified, a recipient availability indication is generated for the transmission and the indication is provided to the recipient. The recipient has the option to modify his/her availability indication by updating his/her availability data.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 shows a more detailed view of the agent shown in FIG. 1;

FIG. 3 illustrates a representation of data used in conjunction with the present invention;

FIGS. 4A and 4B show a flowchart of steps used to implement aspects of the present invention;

FIG. 5 illustrates an exemplary display according to the present invention; and

FIG. 6 illustrates an exemplary availability indication of the present invention.

### DETAILED DESCRIPTION

The present invention relates to a system and method for managing an incoming transmission. A recipient, also referred to herein as a user, receives an incoming transmission and a classification for the incoming transmission is determined based on one or more pre-defined criteria. An availability level of the recipient is established as a function of recipient availability data and the classification; and the availability level of the recipient is presented to the recipient.

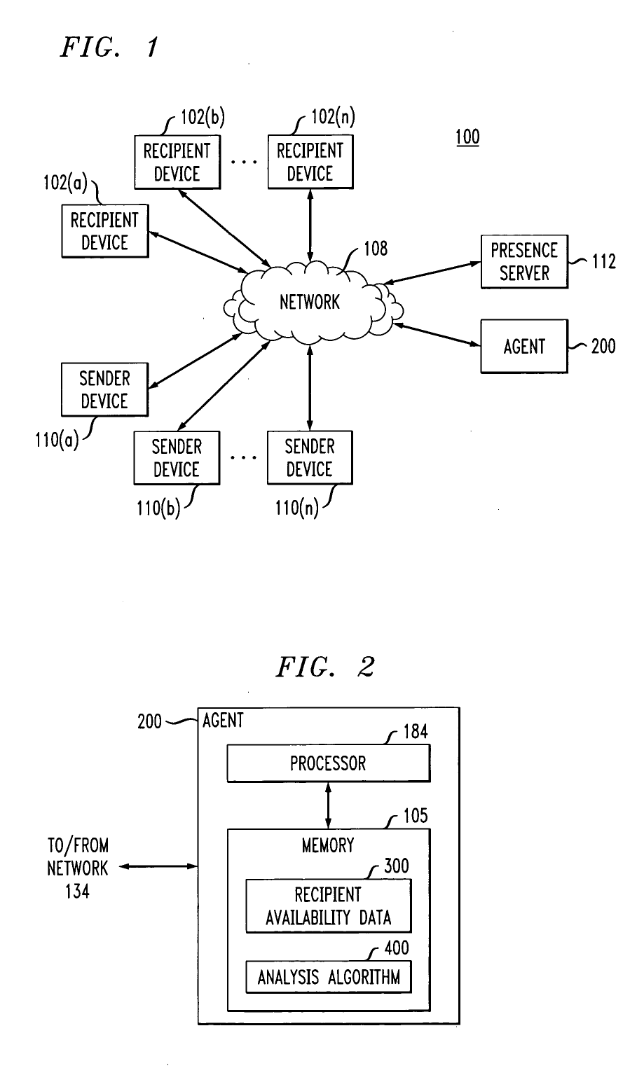

FIG. 1 illustrates a network environment 100 in which the present invention can operate. Recipient devices 102(a) through (n) (where n is any suitable number), generally referred to herein as recipient devices 102, are coupled to network 108. Sender devices 110(a) through (n) (where n is any suitable number), generally referred to herein as sender devices 110, agent 200 and server 112 are also coupled to network 108. The network 108 utilizes standard interconnections, which may include, for example, wired or wireless connections to interconnect components (e.g., recipient devices 102, sender devices 110, agent 104 and server 112) of the network 108. Network 108 is a network of interconnected terminals or devices. The network may be, for example, a PBX (private branch exchange), WLAN (wireless local area network), a LAN (local area network), a WAN (wide area network), Internet, PSTN (public switched telephone network) or a combination thereof, or other interconnection of processing or communication devices.

Recipient devices 102 are capable of receiving transmission events and sender devices 110 are capable of sending transmission events. Transmission events include, for example, data communications, voice communications, text-to-speech data, video data, instant messages, e-mails and audio data. Recipient devices 102 and sender devices 110 may include, for example, telephones, hand-held devices, facsimile machines, scanners, printers, cell phones, personal digital assistants (PDA), networked devices, mobile devices using SMS (short message system) or a similar transport mechanism, multiprocessor systems, microprocessor-based or programmable consumer electronic devices, network PC's, and other devices with processing and output capabilities.

Recipient devices 102 are used to present information related to transmission activity. This may include, for example, a sender's classification level, sender's availability level and the recipient's availability indication that was displayed to each sender in response to a transmission. The recipient devices 102 can provide output by “reading” to the user using text-to-speech technology or providing an output retrieved from a memory or database.

A recipient may use one or more of devices 102 to establish availability data or modify availability data. Also, the availability data may be obtained implicitly, for example, by monitoring a recipient's telephone line status, computer log-on status, email activity, electronic calendar entries, office lights and other passive activity indications. Further examples of this type of recipient availability data are disclosed in U.S. application Ser. No. 10/672,633, “Method and Apparatus for Delivering a Voice Mail Message with an Indication of the Presence of the Sender,” filed Sep. 26, 2003, which is hereby incorporated by reference in its entirety herein.

Typically, the sender devices 110 initiate transmission events and receive a response indicating an availability level of the recipient. This availability response may include an indication that the sender should attempt to contact the recipient at another time or via another medium, e.g., via email instead of telephone.

Agent 200 is coupled to network 108 and is in bi-directional communication with recipient devices 102, server 112 and sender devices 110. Agent 200 may include, for example, automated agents, communication agents, personal communications managers, or personal agents adapted to perform complex processing and/or data manipulations with respect to managing communication streams or transmission events. The agent 200 may also use sophisticated presence information, such as calendar and schedule information, rules and settings to determine an availability level of a recipient. Examples of agent 200 are described in U.S. application Ser. No. 10/672,635, “Programmable Presence Proxy for Determining a Presence Status of a User,” filed Sep. 26, 2003, which is hereby incorporated by reference in its entirety herein.

Agent 200 receives incoming transmissions from sender devices 110 or network 108. An incoming transmission may include, for example, attempted and received communication streams, facsimiles, telephone calls, data packets, emails, video data, audio data and instant messages (IM). The agent 200 can access availability information for a recipient (including information specific to a recipient's availability at particular recipient devices) as well as obtain information related to the incoming transmission event, such as a classification of a sender, type of transmission, content of transmission, medium of transmission etc.

Server 112, coupled to network 108, is typically a computer that includes a processor and a memory. The processor and memory provide processing capabilities and nonvolatile storage of computer-executable instructions, data structures, program modules and other data for the server 112.

A number of program modules may be stored on the server 112, including an operating system, application programs and other program modules.

Although only one agent 200 is shown in FIG. 1, one or more additional agents could be used to perform the necessary processing. For example, a first agent could be used to receive the transmission, access the recipient availability data and generate a classification for the sender and an availability level for the recipient and a second agent could be used to provide the response to selected sender and/or recipient devices 110 and 102, respectively.

FIG. 2 illustrates a more detailed view of agent 200, shown in FIG. 1. As seen in FIG. 2, agent 200 includes a processor 184, an interconnector 134 and a memory 105, which includes storage modules 300 and 400.

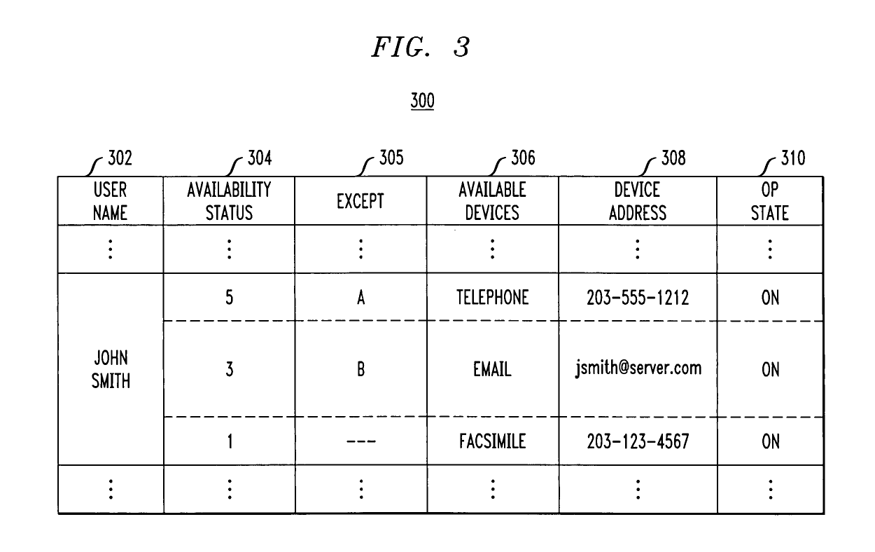

Storage module 300, discussed below in conjunction with FIG. 3, is adapted to store recipient availability data, as described herein, which may include rules or parameters, which may change depending on the activities, schedule and whereabouts of a recipient. For example, recipients may have one availability criterion when they are in their office, another for when they are in a meeting and yet another for when they are traveling.

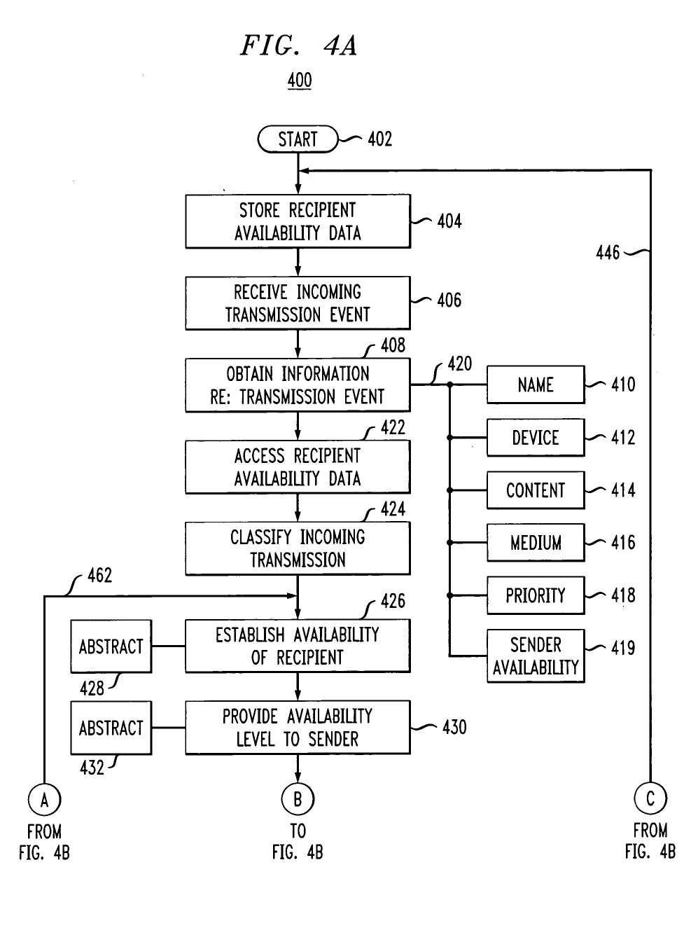

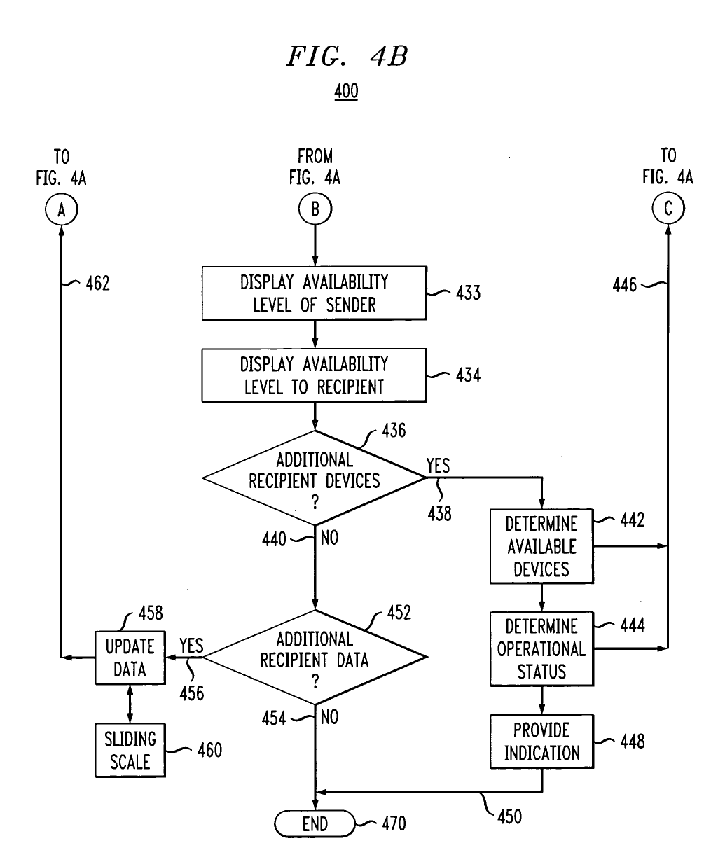

Storage module 400, discussed below in conjunction with FIG. 4, is adapted to store an analysis algorithm used to generate a recipient availability indication. This indication is generated by processing available data relating to the recipient, and the transmission. This data includes, for example, recipient availability data, transmission data, classification data and sender availability data

Processor 184, which is coupled to memory 105, is adapted to retrieve data from remote locations and use the data stored in the modules of memory 105 (e.g., 300 and 400) to perform the necessary data manipulations. Such processing includes, for example, generating a classification level for a communication, an availability level for a sender and an availability indication for a recipient. The processor can transmit these quantities to selected one or more devices, as shown in FIG. 1.

Thus, the agent 104 provides status information, via communication link 134, to the network, and thus to recipient device(s), or other output facilities specified by the user. The information may also be accumulated in a log file, or manifest, which allows the user to keep a record of incoming transmissions and data related to how each transmission was dealt with. This includes for example, the level of sender availability, classification of the transmission and the availability indication provided to each sender. The user can validate that the agent is operating properly and the user can further customize their availability by adjusting their coarse availability setting as well as inputting specific exceptions.

FIG. 3 illustrates exemplary data structure 300 for recipient availability database, which may be stored in memory, as shown in FIG. 2. The recipient availability data 300 represents information for each user of the system and may include data from a plurality of sources. More particularly, the recipient availability information may be gathered from user input, presence sensing, calendar information, pre-established criteria, scheduled meetings, holidays, vacation time, passive monitoring of user activity and other time that is deemed either unavailable or when the recipient is deemed unable to receive a particular type of transmission.

The availability data 300 is accumulated and stored and may be accessed when a transmission event occurs so that the agent can generate an availability level based on the user availability or presence. The data can be transmitted to, and accessed by, a remote workstation.

In FIG. 3, field 302 indicates a data field for a user name, field 304 indicates a data field for presence status for each user, field 305 indicates a data field for exception data, field 306 indicates a data field for available devices the user can access, field 308 indicates a data field for an address of each device and field 310 indicates a data field for an operational status of each device.

Field 302 indicates user names for a plurality of users. Specifically, one example is that a user is identified as “John Smith” in the user-name field 302, has a plurality of possible presence status indicators associated with various devices. Availability status indicator field 304, exception data field 305, available devices field 306, device address field 308 and operational status field 310 show one possible example of recipient availability status for user John Smith. In the example shown, one telephone line, in field 306, with device address shown as telephone number 203-555-1212, in field 308 has an availability level of “5,” shown in field 304 indicating that the recipient does not wish to receive a call on that line. The availability level of “5” may be the result of a coarse availability level. This coarse level can be established by recipient input, monitoring recipient activity, or a recipient setting, such as a sliding scale. The telephone line is operational so field 310 provides an “on” indication. Field 305 indicates that exception status “A” has been invoked. Exception status “A” could be that specified numbers, i.e., spouse's phone number, will be received by the recipient and the recipient will appear unavailable for other calls. Thus, the exception field 305 enables a recipient to further modify their availability level.

An email device listing with a URL (uniform resources locator) (jsmith@server.com) is a reception device for the user and field 304 indicates that the email address has been assigned a coarse availability rating of “3.” Field 305 indicates an exception status “B”, which could be that even though the coarse indication is a “3,” the “B” rating will not permit emails that originated from websites that contain adult content or unknown senders. The user is logged into the email account so field 310 indicates that the operational status is “on.” If the user were not logged into the email account, the operational status would indicate “off.” Therefore, it is an embodiment of the invention that when the email is “off,” the rating of “3” would be changed by the agent, as described herein, to a rating indicating that the user is not logged onto the email account, even though the recipient did not change the coarse availability level of “3.” This is particularly beneficial for an instant message (I/M) sender, who would receive a response that the user is not available and therefore, an instant reply from the user is not likely.

A facsimile device is also indicated as a reception device for the user. The coarse setting is a “1” rating, indicating that the availability is high. Field 305 does not indicate that there is an exception, so all incoming facsimiles will be received. The device has an address of 203-123-4567 and the device is “on.”

The user may modify or update the coarse indicators, of field 304, and/or the exception data of field 305, to reflect changes in his/her schedule. Furthermore, modifications to an electronic calendar or spreadsheet may be used to modify the data of FIG. 3.

FIGS. 4A and 4B show a flowchart 400 of steps that may be used to implement an analysis algorithm of the present invention. These steps, or functional features, are shown as blocks and are suitably stored on a computer-readable medium, which can be read by a computer, or other processing device as described herein. The steps of flowchart 400 may be used to generate program code or perform a series of data manipulations. While FIGS. 4A and 4B show steps in a particular sequence, this is for explanation purposes, and it is within the scope of the invention that the specific sequence may be modified as a function of specific applications, program code and design considerations.

Step 402 begins the algorithm. Step 404 stores recipient availability data. This data represents the presence and activity status of a user, as discussed herein. The recipient availability data may be stored in a remote memory, local memory, removable memory or any computer-readable medium.

Step 406 receives an incoming transmission event by a recipient. This transmission event is typically received by an automated agent and may be a telephone call, facsimile, e-mail, i/m, video or other communication.

Step 408 obtains information about the transmission. This information is typically any data relating to the transmission and specific examples are shown in blocks 410, 412, 414, 416, 418 and 419, which are reached via line 420. Specifically, step 410 obtains the name of a sender; step 412 obtains the type of transmission device (i.e., telephone, computer, facsimile); step 414 obtains content of the transmission; step 416 obtains a medium of the transmission (voice, text, and video); step 418 obtains priority status indicators; and step 419 obtains an availability indication of the sender. The priority status indicator may be a special access code or other information provided by a transmission device or sender that gives the transmission a heighten level of access. The information obtained may be automatically supplied (e.g., ANI (automatic number identification)) or may be obtained by the agent, such as examining the content, seeking a priority indicator, establishing whether the area code is significant or any other relevant information. Step 422 accesses the recipient availability data. This data typically includes a setting of general availability for a recipient as well as any exceptions to the general availability that the recipient has provided.

Step 424 classifies the incoming transmission. This classification is a result of the information about the transmission (sender name, sender number, device type, content, medium, priority, sender availability), described in relation to step 408.

Step 426 establishes an availability level of the recipient for the incoming transmission. This availability level is a function of the recipient availability data and the classification level of the transmission. For example, if the classification level is low, meaning that the transmission is either from an unknown sender, or it is a voice call (typically emails will be given priority over telephone calls, since the recipient will be required to stop what they are doing to take a phone call while an email can read at a later time) the availability response may also be low (meaning the recipient will not respond), even if the availability data does not indicate that the recipient is very busy. Further, the availability response may be very high even when the recipient is busy because the transmission is from a supervisor or spouse. The grouping of the caller from an inner circle (family, supervisor) to an outer circle (telemarketers, unknown callers) is a factor in determining recipient availability.

Step 428 generates an abstraction. The abstraction may be, for example, a representation of a device or location in generic terms. Specifically, an abstraction may indicate that a recipient is available by telephone; however, the recipient may be working from home and does not wish to provide their home telephone number so the abstraction provides an indication that the recipient is available by phone and give a voicemail number. Similarly, the recipient may be available by one of a plurality of email accounts so the abstraction provides that email is the highest available medium, without giving a specific email address.

Step 430 provides the availability level to the sender. This may include providing the level to a plurality of sender devices and may also include the abstraction, shown as step 432. Step 433 provides an availability level of the sender to the recipient. The availability level of the sender is typically obtained if the sender is on a buddy list, group or otherwise provides that information, for example, as a component of step 408. This sender information could include when the sender is out of the office, in a meeting, on the phone, involved in an I/M session, or other activity. Step 434 provides the recipient availability level to a recipient device.

Decision step 436 determines whether the availability response and/or transmission should be routed to another reception device. If so, “yes” line 438 leads to step 442 that determines available recipient devices. Step 444 establishes an operational status, such as “on” or “off,” for each reception device thereby determining possible destinations for the response and/or the transmission event. For example, if a recipient does not have their cell phone on, the operational status of that device will be “off.” Line 446, which includes the output from steps 442 and 444, leads to step 404 and provides the available reception device data and operational state of reception devices to the recipient availability data. Step 448 provides any combination of the transmission event, notification of the event and the response to the event to one or more reception devices of the recipient, such as an email account, facsimile machine, voicemail or other reception device. Line 450 leads to end step 470.

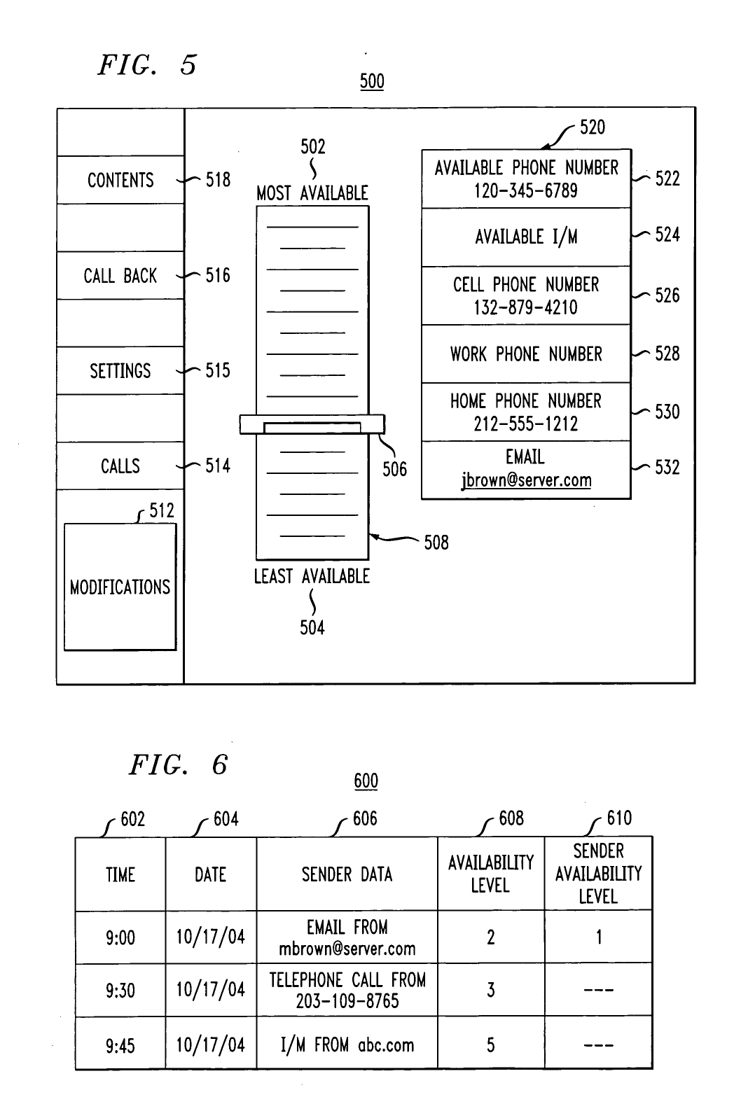

Line 440 leads from decision step 436 to decision step 452 that enables the recipient to update availability data. Line 456 leads to step 458, which updates the recipient availability data. Step 460 enables updating recipient availability data using a sliding scale (see FIG. 5). For example, the recipient may wish to update their availability information based on events that transpire or changes in their schedule. The recipient can modify the data “on-the-fly” by changing the availability setting or changing the exception data. Line 462 leads to step 426, which establishes the availability level of the recipient based on the updated information. Line 454 leads to end step 470.

FIG. 5 shows an exemplary display 500 according to an embodiment of the present invention. Display 500 is typically a user interface on a computer that allows a user to input data and change settings using a keyboard and/or a mouse. Display 500 includes a sliding scale availability icon 508, available device indicators 520 and data fields 512, 514, 515, 516 and 518.

Sliding scale availability icon 508 includes “most available” level 502, “least available” level 504 and a setting mechanism 506 that is adjustable between the two levels as, for example, a rheostat switch, which may be adjusted using a mouse, or other input mechanism.

Available device indicators 520 include indicators, such as available telephone number 522, available I/M 524, available cell phone 526, available work phone 528, home phone 530 and email 532.

Data field 512 indicates that a user may modify their availability data. Data field 514 indicates that a user may note telephone calls. Data fields 515, 516 and 518 indicate that a user may input other data.

As shown by FIG. 5, a user can set switch element 506 to a particular level and then reset specific parameters in the modification field 512. For example, a user may set their availability as relatively unavailable by moving switch 506 to approximately 80% unavailable. However, the user can then modify the availability level by making exceptions in the modification field 512 for particular calls or meetings. This availability level, with modifications can be stored in a memory, electronic calendar or other data structure that can be accessed by other processors.

FIG. 6 shows an exemplary availability indication output 600. Output 600 is typically displayed at a recipient device, as described herein. Fields 602, 604, 606, 608 and 610 show data fields for: time; date; sender data; recipient availability level provided; and sender availability level, respectively. Output 600 shows that at 9:00 on October 17, an email from mbrown@server.com was received and an availability level of “2” was provided for this communication. The level “2” is a relative quantity on a scale. For example, the scale may be from “1” to “5,” with “1” being the most available and “5” being the least available. In this example, a recipient may have set a coarse availability level at “2.5” but a “higher,” or more available, indication of “2” was provided to the sender of the email. The higher indication is a result of the email address being recognized, the sender availability being a “1” and the medium of the transmission being an email, rather than a telephone call. Thus, although the recipient set the availability at “2.5” the more available setting of “2” was provided to the sender and the recipient has notification of the availability response provided to the sender.

A second incoming transmission is shown by output 600. At 9:30 on October 17, a telephone call was received from 203-109-8765 and the availability level of “3” was generated. The “3” reflects that the recipient availability was set at “2.5” and the classification of the call decreased the availability level since the call was from an unrecognized number. There is no sender availability data associated with this communication so the field 610 is empty.

Furthermore, at 9:45 on October 17, an I/M from abc.com was received. The recipient availability for this transmission was a “5,” meaning the recipient was the least available. Thus, even though the recipient may have set their availability level at “2.5,” the I/M was identified as originating from an unknown source so the recipient was less available. The recipient has visibility to the availability indication of “5” that was provided to the sender of the I/M.

FIG. 6 shows an example of three transmissions; however, there could be any number of transmissions received. Also, FIG. 6 shows a manifest display in which a series of transmissions and the corresponding level are displayed; however, it is also an embodiment of the invention that the information could be displayed as a “tickertape” in a frame, footer, banner or tool bar on a computer monitor or other output device. This provides a continuously displayed data to which the recipient can respond.

It is yet another embodiment that two agents could be used to manage one or more transmission events. For example, a first agent could be used to receive the availability data of a recipient, including any exceptions, and a second agent could be used to receive transmission events, access the availability data from the first agent, process the event and provide the availability level to the sender and to the recipient.

Those skilled in the art will appreciate that embodiments of the disclosed invention may also be practiced in distributed computing environments where tasks are performed by local and remote processing devices that are linked through a communications network. In a distributed computing environment, program modules may be located in both local and remote memory storage devices.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. When information is transferred or provided over a network or other communications connection to a computer, the computer properly views the connection as a computer-readable medium. Thus, such a connection is also properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that these and other embodiments and variations shown and described in the examples set forth above and the figures herein are merely illustrative of the principles of this invention and that various modifications may be implemented by those skilled in the art without departing from the scope and spirit of the invention.

1. A method for providing availability data, comprising:
receiving a transmission from a sender;
generating a recipient availability indicator; and
providing the recipient availability indicator to the recipient.

2. The method of claim 1, wherein the recipient availability indicator is generated as a function of recipient availability data and a classification level for the transmission.

3. The method of claim 1, further comprising providing the recipient availability indicator to the sender.

4. The method of claim 1, wherein the classification level for the transmission is a function of one or more of the following: sender name, sender device, sender priority indicator, sender availability data and transmission content.

5. The method of claim 1, further comprising providing a modified availability indicator to the sender as a function of modified recipient availability data.

6. The method of claim 1, wherein the recipient availability data is accessed from a plurality of locations.

7. The method of claim 1, wherein the step of generating the recipient availability indicator further comprises:
identifying a medium of the transmission; and
modifying the recipient availability indicator as a function of the medium of the transmission.

8. The method of claim 7, wherein transmissions containing voice data are assigned a first status and transmissions containing text data are assigned a second status.

9. The method of claim 1, wherein the step of generating the recipient availability indicator further comprises:
utilizing an abstraction of recipient availability,
wherein the step of providing the recipient availability indicator to the sender includes providing the abstraction to the sender.

10. The method of claim 1, wherein the step of generating the recipient availability indicator includes identifying available reception devices.

11. A method for managing an incoming transmission comprising:
determining a classification for one or more incoming transmissions based on one or more pre-defined criteria;
establishing an availability level of a recipient as a function of recipient availability data and the classification; and
presenting the availability level of the recipient to the recipient.

12. The method of claim 11, further comprising providing the availability level of the recipient to a sender.

13. The method of claim 11, wherein the step of establishing the availability level of the recipient further comprises updating the availability level of the recipient as a function of additional recipient availability data.

14. The method of claim 11, further comprising providing a reception indicator to the sender indicating available reception devices, and
wherein the presenting step includes presenting to the recipient the reception indicator being provided to the sender.

15. A system for providing availability data comprising:
a memory; and
at least one processor, coupled to the memory, operative to:
receive a transmission from a sender;
generate a recipient availability indication; and
provide the recipient availability indication to the recipient.

16. The system of claim 15, wherein the recipient availability indication is generated as a function of recipient availability data and a classification level for the transmission and wherein the classification level for the transmission is a function of one or more of the following: sender name, sender device, sender priority indicator, sender availability data and transmission content.

17. The system of claim 15, wherein the at least one processor is further operative to provide the recipient availability indication to the sender.

18. The system of claim 17, wherein the at least one processor is further operative to provide a modified availability response to the sender as a function of modified recipient availability data.

19. The system of claim 15, wherein the at least one processor is further operative to provide a reception indicator indicating available reception devices.

20. An article of manufacture for providing availability data comprising a machine readable medium containing one or more programs that when executed implement the steps of:
receiving a transmission from a sender;
generating a recipient availability response; and
providing the recipient availability response to the recipient.

21. The article of manufacture of claim 20, wherein the recipient availability response is generated as a function of recipient availability data and a classification level for the transmission and wherein the classification level for the transmission is a function of one or more of the following: sender name, sender device, sender priority indicator sender availability and transmission content.

22. The article of manufacture of claim 20, further comprising program code for providing a modified recipient availability response to the sender as a function of the modified recipient availability data.

23. The article of manufacture of claim 20, further comprising program code for providing a reception indicator indicating available reception devices.

24. An article of manufacture for managing an incoming transmission comprising a machine readable medium containing one or more programs that when executed implement the steps of:
determining a classification for one or more incoming transmissions based on one or more pre-defined criteria;
establishing an availability level of a recipient as a function of recipient availability data and the classification; and
displaying, at one or more recipient devices, the availability level of the recipient.

25. The article of manufacture of claim 24, further comprising:
program code for updating the availability level of the recipient as a function of additional recipient availability data.

26. A method for providing an availability indicator in response to a transmission sent from a sender and having a classification level, comprising:
generating an availability indicator as a function of recipient availability data and the classification level; and
providing the availability indicator to the recipient.

27. The method of claim 26, further comprising providing the availability level to the sender.

28. The method of claim 26, further comprising generating an updated availability indicator as a function of updated recipient availability data.
